(19) United States
(12) Patent Application Publication
(10) Pub. No.: US 2009/0150046 A1
(43) Pub. Date: Jun. 11, 2009

(54) Method for controlling an internal combustion engine and internal combustion engine

(76) Inventors: Erwin Achleitner, Obertraubling (DE); Christopher Forster, Liederbach (DE); Christoph Kollner, Eschbron (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/028,167

(22) Filed: Feb. 8, 2008

(30) Foreign Application Priority Data
Feb. 12, 2007 (DE) 10 2007 006 865.6

(51) Int. Cl. F02D 41/30

(52) U.S. Cl. 701/103; 123/447

(57) ABSTRACT

A control method for an internal combustion engine with at least one pressure accumulator in which fuel is stored under pressure, in order to supply pressurized fuel to at least one injection valve, and at least two high-pressure pumps which are connected to the at least one pressure accumulator in such a way that they can supply fuel to this at least one pressure accumulator either jointly or separately, with, if at least one condition is fulfilled, the high-pressure pumps being operated in a special operating mode in which only one of the high-pressure pumps supplies fuel to the at least one pressure accumulator, and with the high-pressure pumps being otherwise operated in a normal operating mode in which the at least two high-pressure pumps jointly supply fuel to the at least one pressure accumulator.

### CROSS-REFERENCE TO RELATED APPLICATIONS

This application claims priority to German Patent Application Number 10 2007 006 865.6 filed Feb. 12, 2007, and which is incorporated herein by reference in its entirety.

### TECHNICAL FIELD

The invention relates to a method for controlling an internal combustion engine and to an internal combustion engine with a control device which is designed so that it can perform said method.

### BACKGROUND

With modern internal combustion engines, the trend towards higher torque and power output is discernable. A power increase can be changed particularly by increasing the displacement, usually associated with an increase in the number of cylinders and/or by supercharging the internal combustion engine by means of an exhaust gas turbocharger or a mechanical compressor. Furthermore, direct fuel injection is increasingly used. In this case, the fuel is injected under high pressure directly into the combustion chamber. Special high-pressure pumps are used to realize the high injection pressure of approximately 150 to 200 bar (for spark-ignition engines) required for this. Extremely high requirements are required with regard to the delivery rate of the high-pressure pumps to guarantee stable combustion under full load. At the same time, due to the strong competition in the automobile industry, intensive efforts are made to keep the manufacturing costs of internal combustion engines as low as possible.

The assignment of an independently operating fuel supply system to each cylinder bank of powerful internal combustion engines with two or more cylinder banks is known from prior art. This system has, however, proved to be very expensive because the number of components and the amount of pipework required for the fuel supply is multiplied many times. Furthermore, the space requirement in the engine compartment is very great. This solution has also proven to be relatively inflexible particularly with respect to emergency operation because if one of the fuel supply systems fails, the complete cylinder bank has to be shut down or operated at low pressure.

### SUMMARY

A control method and an internal combustion engine can be provided by means of which a greater flexibility with regard to the fuel supply is possible and which enables the manufacturing costs to be reduced.

According to an embodiment, in a method for controlling an internal combustion engine with at least one pressure accumulator in which fuel is stored under pressure, in order to supply fuel under pressure to at least one injection valve, at least two high-pressure pumps which are connected to the at least one pressure accumulator in such a way that said high-pressure pumps can supply the at least one pressure accumulator with fuel either jointly or separately, the method comprises the step of: if at least one condition is fulfilled, operating the high-pressure pumps in a special operating mode in which only one of the high-pressure pumps supplies fuel to the at least one pressure accumulator and otherwise the high-pressure pumps are operated in a normal operating mode in which the at least two high-pressure pumps jointly supply the at least one pressure accumulator with fuel.

According to a further embodiment, a controllable valve being assigned to each of the at least two high-pressure pumps, by means of which the amount of fuel supplied from the respective high-pressure pump to the at least one pressure accumulator can be adjusted, and a control device being assigned to the internal combustion engine, which is connected to the valves and controls the pressure in the pressure accumulator by specifying a separate pilot control value for each valve, wherein the method further may comprise the steps of: to set the pressure in the pressure accumulator in the special operating mode, applying a pilot control value to the valve of the particular high-pressure pump which supplies fuel to the at least one pressure accumulator and then, determining a correction value for this valve, in order to correct the pressure in the pressure accumulator to a preset desired pressure value, and assessing the functional capability of the respective high-pressure pump on the basis of the determined correction value. According to a further embodiment, the respective high-pressure pump may be assessed as defective if the associated correction value exceeds a preset limit value. According to a further embodiment, if one of the high-pressure pumps is assessed as defective, the valves can be controlled in the succeeding normal operating mode in such a way that the high-pressure pumps deliver different amounts of fuel to the at least one pressure accumulator. According to a further embodiment, the valves may be controlled in such a way that they are in an operating range in which there is an essentially linear relationship between the correcting variable for the respective valve and the amount of fuel flowing through the respective valve. According to a further embodiment, a controllable valve, by means of which the amount of fuel delivered by the respective high-pressure pump to the at least one pressure accumulator can be set, being assigned to each of the at least two high-pressure pumps, and a control device being assigned to the internal combustion engine, with the control device being connected to the valves and the pressure in the pressure accumulator being controlled by the specification of a pilot control value for each of the valves, the method further may comprise the steps of: in special operating mode, to set the pressure in the pressure accumulator, initially supplying a pilot control value to the valve of the particular high-pressure pump which supplies fuel to the at least one pressure accumulator and then, determining a correction value for this valve in order to correct the pressure accumulator to a preset desired pressure value, and during the succeeding control of the pressure in the pressure accumulator in the normal operating mode, carrying out the pilot control of this valve taking account of this correction value. According to a further embodiment, the process steps may be performed with respect to all the valves and the determined correction values, being assigned to the respective valves. According to a further embodiment, a control device may control the valves during the control of the pressure in the normal operating mode in such a way that each high-pressure pump delivers the same amount of fuel to the at least one pressure accumulator. According to a further embodiment, the at least one condition then being fulfilled if the valve of the particular high-pressure pump that is meant to supply fuel to the pressure accumulator during the special operating mode can be operated in the special operating mode in an operating range in which there is an essentially linear relationship between the correcting variable for the valve and the amount of fuel flowing through the valve. According to a further embodiment, the at least one condition then being fulfilled if the internal combustion engine is in an operating range in which the delivery rate of one of the high-pressure pumps is sufficient to set the pressure in the pressure accumulator to the desired pressure value. According to a further embodiment, the internal combustion engine may have two pressure accumulators and the at least one condition then being fulfilled if one of the high-pressure pumps is found to be defective. According to a further embodiment, the at least one condition then being fulfilled if at least one operating variable of the internal combustion engine changes by not more than a preset limit amount over a specified time period. According to a further embodiment, a changeover from the special operating mode to the normal operating mode may take place during the fulfillment of a further condition. According to a further embodiment, the further condition then being fulfilled if the internal combustion engine reaches an operating range in which the delivery rate of the high-pressure pump is no longer sufficient to set the pressure in the pressure accumulator to the desired pressure value. According to a further embodiment, the further condition then being fulfilled if the valve of the high-pressure pump is operated in an operating range in which there is no linear relationship between the control variable for the valve and the amount of fuel flowing through the valve. According to a further embodiment, the further condition then being fulfilled if the determination of the correction value for the valve has been completed.

According to another embodiment, an internal combustion engine may comprise at least one pressure accumulator in which fuel is stored under pressure, in order to supply at least one injection valve with pressurized fuel, at least two high-pressure pumps which are connected to at least one of the pressure accumulators in such a way that they can supply fuel to this at least one pressure accumulator either jointly or separately, and a control device which is operable to adjust the amount of fuel which can be delivered by the high-pressure pumps to the pressure accumulators, and if at least one condition is fulfilled, to operate the high-pressure pumps in a special operating mode in which only one of the high-pressure pumps supplies fuel to the at least one pressure accumulator, and otherwise, to operate the high-pressure pumps in a normal operating mode in which the at least two high-pressure pumps jointly supply fuel to the at least one pressure accumulator.

According to a further embodiment, the high-pressure pumps may be single-cylinder piston pumps.

### BRIEF DESCRIPTION OF THE DRAWINGS

The invention is explained in more detail below with reference to the accompanying drawings, in which;

FIG. 1 shows a schematic representation of an internal combustion engine;

FIG. 2 shows a schematic representation of the construction of an internal combustion engine with two pressure accumulators;

FIG. 3 shows a schematic representation of the characteristic curves of the valves for the high-pressure pumps;

FIG. 4 shows an exemplary embodiment of a control process in the form of a flow diagram;

FIG. 5 shows a further exemplary embodiment of a control process in the form of a flow diagram;

### DETAILED DESCRIPTION

A control method according to an embodiment refers to an internal combustion engine with at least one pressure accumulator in which fuel is stored under pressure, in order to supply at least one injection valve with pressurized fuel. The internal combustion engine also has at least two high-pressure pumps which are coupled with the at least one pressure accumulator in such a way that they can supply this at least one pressure accumulator jointly, and also separately, with fuel. According to the method, to meet one requirement, the high-pressure pumps are operated in a special mode in which only one of the high-pressure pumps supplies the at least one pressure accumulator with fuel. Otherwise, the high-pressure pumps are operated in a normal operating mode in which the at least two high-pressure pumps jointly supply the at least pressure accumulator with fuel.

The internal combustion engine to which the method relates is characterized by a cost-effective and reliable solution for the fuel supply to the at least one pressure accumulator. In that the fuel supply for each pressure accumulator in normal operating mode is carried out by means of the at least two high-pressure pumps, pressure pulses in the pressure accumulator can be noticeably reduced and an adequate fuel supply, even on full load, can be ensured by using cost-effective and compact single-cylinder, piston pumps. In contrast, with the solution known from prior art, to achieve the same effect for each cylinder bank or pressure accumulator, a more expensive multi-cylinder piston pump with greater dimensions has to be provided in each case.

A very high flexibility also results because, according to various embodiments, the high-pressure pumps can be operated in the special operating mode or in normal operating mode depending on at least one freely definable condition. If, with an internal combustion engine with several cylinder banks, one cylinder bank has to be shut down because of a defect (by deactivation of the inlet valves), the remaining cylinder banks continue in normal operating mode to be supplied with fuel by all the high-pressure pumps, so that the internal combustion engine can also achieve a higher power output with only one cylinder bank. On the other hand, it is possible for example to supply all the cylinder banks with the remaining functioning high-pressure pumps in the event of a defect in one of the high-pressure pumps, which has a positive effect on the driving comfort. Furthermore, it is possible according to various embodiments to perform individual diagnosis or characteristic matching for the individual high-pressure pumps or other components when operating the high-pressure pumps in the special operating mode.

According to an embodiment of the method, a controllable valve, by means of which the amount of fuel supplied by the respective high-pressure pump to the pressure accumulator can be set, may be assigned in each case to each of the at least two high-pressure pumps. Furthermore, a control device is assigned to the internal combustion engine, which is connected to the valves and which controls the pressure in the pressure accumulator by specifying a pilot control value for each of the valves. According to various embodiments, to set the pressure in the pressure accumulator in the special operating mode, a pilot control value is applied to the valve of the high-pressure pump which supplies the at least one pressure accumulator and a correction value for this valve is determined, in order to correct the pressure in the pressure accumulator to a preset desired pressure value. The functional capability of the respective high-pressure pump is then assessed on the basis of the determined correction value.

In the embodiment of the method, the respective high-pressure pump may be assessed as defective if the associated correction value exceeds a preset limit value.

The pressure in the pressure accumulator is controlled by presetting a pilot control value for the valves and then correcting to the desired pressure value. To determine the pilot control value, a standard operating characteristic of the controllable valves, for example in the form of a characteristic curve, is stored in the control device. The pilot control of the valves and the setting of the pressure in the pressure accumulators are also based on the assumption that all the high-pressure pumps are fully functional. A defect in the high-pressure pumps or associated valves can therefore lead to a significant deviation from the set pressure value after the specification of the pilot control value. The correction value then determined by the control device for correcting this deviation is therefore correspondingly large and represents a measure of the functional capability of the high-pressure pumps and the associated valves. Therefore, it is possible to assess the functional capability of the respective high-pressure pump and/or associated valve on the basis of an evaluation of the associated correction value. The embodiments therefore enable a simple and cost-effective assessment of the functional capability of the individual high-pressure pumps and associated valves. A defect according to an embodiment is any deviation of the operating behavior of the high-pressure pumps and/or of the associated valves from the normal operating behavior during full functional capability. This can for example be due to ageing, wear or fracture of individual components. However, total failure of the high-pressure pumps and of the valves is also included.

In one embodiment of the method, in the event of one of the high-pressure pumps being assessed as defective, the valves in the succeeding normal operating mode are controlled in such a way that the high-pressure pumps deliver different amounts of fuel to the at least one pressure accumulator.

If one of the high-pressure pumps and/or associated valves is identified as defective, the valves are operated in normal operating mode in such a way that, for example, a reduced delivery rate of the defective high-pressure pump is compensated for by the other high-pressure pumps. This enables the pressure in the pressure accumulator to be set to the desired pressure value even with one defective high-pressure pump.

According to one embodiment of the method, the valves are controlled in such a way that they are in an operating range in which an essentially linear relationship exists between the correcting variable of the respective valve and the amount of fuel flowing through the respective valve.

This embodiment ensures that all the valves are within the linear operating range which renders the control thereof significantly simple and precise.

According to one embodiment of the method, a controllable valve is assigned to each of the at least two high-pressure pressure pumps, by means of which the amount of fuel supplied by the respective high-pressure pump to the pressure accumulator can be adjusted. Furthermore, a control device, which is connected to the valves and which controls the pressure in the pressure accumulator by specifying a pilot control value for each valve, is assigned to the internal combustion engine. According to the method, to set the pressure in the pressure accumulator in the special operating mode, a pilot control value is first applied to the valve of the particular high-pressure pump which supplies fuel to the at least one pressure accumulator and a correction value is then determined for this valve, in order to adjust the pressure in the pressure accumulator to a preset desired pressure value. During the succeeding control of the pressure in the pressure accumulator in the normal operating mode, the pilot control of this valve is performed taking account of this correction value.

Control of the pressure in the pressure accumulator is achieved by specifying a pilot control value for the valves and then adjusting it to the desired pressure value. To determine the pilot control value, the standard operating characteristic of the controllable valves, for example in the form of characteristic curves, is stored in the control device. Due to manufacturing tolerances, the actual operating characteristic of some valves deviates from the standard operating characteristic. In this case, a relatively strong stress of the I component of the control device can occur during the regulation of the pressure in the pressure accumulator and lead to a delayed adjustment of the desired pressure value. The embodiment of the method may enable the pilot control of the valves from the actual operating characteristics of each individual valve to be matched individually. To do this, a correction value is determined for each valve in the special operating mode. The individual correction values are assigned to the valve and stored. Because the pilot control of the valves individually takes account of the correction values during the succeeding control of the pressure in the normal operating mode, stressing of the I component is prevented and a fast adjustment of the desired pressure value is enabled.

In one embodiment of the method, the process steps are performed with respect to all valves and the determined correction values are assigned to the respective valves.

In this way, a unique assigned correction value is determined for each valve, so that an individual matching of the pilot control is possible. This increases the accuracy of the pilot control.

In one embodiment of the method, the control device controls the valves during the control of the pressure in the normal operating mode in such a way that each high-pressure pump supplies the same amount of fuel to the at least one pressure accumulator.

This herewith ensures that each high-pressure pump has the same delivery rate during the service life of the internal combustion engine and premature defects of individual high-pressure pumps due to unevenly distributed delivery rates can be avoided. The operating reliability of the internal combustion engine can be increased in this way.

In one embodiment of the method, the at least one condition is then fulfilled if the valve of the particular high-pressure pump which is meant to supply fuel to the pressure accumulator during the special operating mode can be operated in the special operating mode in an operating range in which there is an essentially linear relationship between the correcting variable for the valve and the flow rate of fuel through the valve.

In one embodiment of the method, at least one condition is then fulfilled if the internal combustion engine is in a operating range in which the delivery rate of one of the high-pressure pumps is sufficient to set the pressure in the pressure accumulator to the desired pressure value.

By means of further embodiments of the method, it can be ensured that a switch to the special operating mode takes place only if matching of the operating characteristics of each valve can be appropriately carried out or the fuel supply can be ensured by only one high-pressure pump.

In one embodiment of the method, the internal combustion engine has two pressure accumulators and the at least one condition is then fulfilled if one of the high-pressure pumps is found to be defective.

Emergency operation of the internal combustion engine is enabled by this embodiment. In the event of a defective high-pressure pump, supply of all the pressure accumulators by the other, functioning, high-pressure pump up to a certain load limit is enabled by a changeover to the special operating mode. This means that individual cylinder banks do not have to be shut down or that operation has to be carried out at low pressure, because in the special operating mode all the pressure accumulators can be supplied with fuel by only one high-pressure pump.

In one embodiment of the method, the at least one condition is fulfilled if at least one operating variable of the internal combustion engine changes by not more than a preset limit amount over a preset time period.

In this way, it is ensured that the internal combustion engine is at a steady-state operating point, which can be advantageous for the accuracy of the determination of the correction variables and the matching of the pilot control to the actual operating characteristic of the valve.

According to one embodiment of the method, a change back from the special mode to the normal operating mode takes place if a further condition is fulfilled.

Furthermore, the further condition according to one embodiment can then be fulfilled if the internal combustion engine reaches an operating range in which the delivery rate of the one high-pressure pump in special operating mode is no longer sufficient to set the pressure in the pressure accumulator to the desired pressure value.

In one embodiment of the method, the further condition can then be fulfilled if the valve of the high-pressure pump is in an operating range in which there is no linear relationship between the correcting variable for the valve and the amount of fuel flowing through the valve.

In one embodiment of the method, the further condition can then be fulfilled if the determination of the correcting value for the valve is completed.

According to further embodiments of the method, a changeover from the special operating mode back to the normal operating mode may take place if the fuel supply to the internal combustion engine to fulfill the performance requirement can no longer be ensured by only one high-pressure pump, the correction value cannot be usefully determined on the basis of an unsatisfactory operating range of the valve or the determination of the correction value has already been completed.

According to another embodiment, an internal combustion engine may have at least one pressure accumulator in which fuel is stored under pressure, in order to supply at least one injection valve with fuel under pressure. The internal combustion engine also includes at least two high-pressure pumps which are connected to at least one of the pressure accumulators in such a way that they can supply this at least one pressure accumulator with fuel either jointly or separately. The internal combustion engine also has a control device which is designed in such a way that the amount of fuel supplied by the high-pressure pumps to the pressure accumulator can be adjusted. If at least one condition is fulfilled, the high-pressure pumps are operated in a special operating mode in which only one of the high-pressure pumps supplies fuel to the at least one pressure accumulator. Otherwise, the high-pressure pumps are operated in normal operating mode in that the at least two high-pressure pumps jointly supply fuel to the at least one pressure accumulator.

Reference is made to the method in respect of the advantages of the internal combustion engine. The advantages given therein similarly apply to the internal combustion engine per se.

In an embodiment of the internal combustion engine, the pumps can be single-cylinder piston pumps.

Single-cylinder piston pumps are shown to be cost-effective and space-saving. Furthermore, pressure fluctuations are reduced by using several single-cylinder piston pumps to supply fuel to the at least one pressure accumulator.

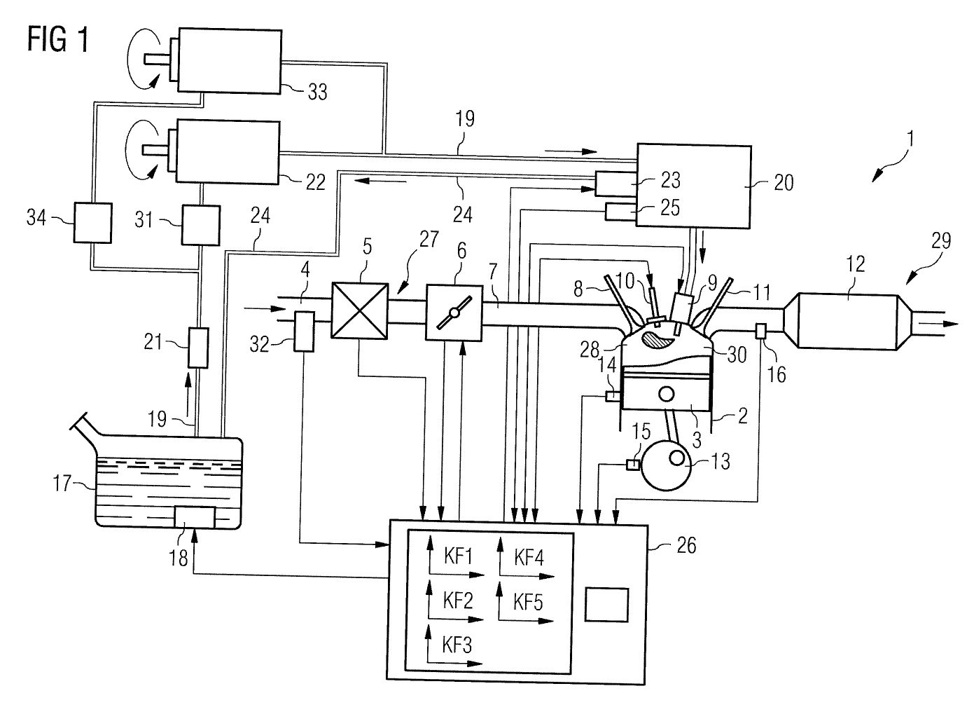

FIG. 1 shows a schematic representation of an internal combustion engine 1 with a fuel supply system. The representation is very simplified for reasons of clarity.

The internal combustion engine 1 includes at least one cylinder 2 and a piston 3 that can be moved up and down in the cylinder 2. The internal combustion engine 1 also includes an intake track 27 in which, downstream of an intake opening 4, an air temperature sensor 32, an air mass sensor 5, a throttle valve 6 and an inlet manifold 7 are arranged. The intake tract 27 terminates in a combustion chamber 30 bounded by the cylinder 2 and the piston 3. The fresh air required for combustion is fed into the combustion chamber 30 through the intake tract 27, with the fresh air supply being controlled by the opening and closing of an inlet valve 8. The internal combustion engine 1 shown here is an internal combustion engine 1 with direct fuel injection, with which the fuel required for combustion is injected directly through an injection valve 9 into the combustion chamber. A spark plug 10 that also projects into the combustion chamber 30 serves to trigger the combustion. The combustion exhaust gases are drawn off via an outlet valve 11 into an exhaust gas tract 29 of the internal combustion engine 1 and purified by means of an exhaust gas catalyzer 12 arranged in the exhaust gas tract 29. The transmission of force to a drive train of a vehicle (not illustrated) takes place by means of a crankshaft 13 connected to the piston 3. The internal combustion engine 1 also has a coolant temperature sensor 14 for detecting the coolant temperature T, a speed sensor 15 for detecting the speed of the crankshaft 13 and a lambda sensor 16 for detecting the exhaust gas composition.

A fuel supply system, which includes a fuel tank 17 and a fuel pump 18 arranged within said fuel tank 17, is assigned to the internal combustion engine 1. The fuel is supplied by the fuel pump 18 via a supply line 19 to a pressure accumulator 20. In this case, it is a common pressure accumulator 20 from which the injection valves 9 for several cylinders 2 are supplied by fuel under pressure. A fuel filter 21, a first high-pressure pump 22 with a first valve 31 assigned to it and a second high-pressure pump 33 with a second valve 34 assigned to it are also arranged in the supply line 19. As explained further in the following, the valves 31, 34 are controllable valves 31, 34 whose degree of opening can be set by applying an excitation current. The purpose of the high-pressure pumps 22, 23 is to supply the fuel, delivered by the fuel pump 18 at a relatively low pressure of approximately 3 bar, to the pressure accumulator 20 at high pressure (typically 150 to 200 bar. The high-pressure pumps 22, 23 are in this case driven by their own drive (not illustrated), for example an electric motor or by means of a suitable coupling to a cam shaft of the internal combustion engine 1 (not illustrated). The high-pressure pumps 22, 23 can be either single-cylinder piston pumps or multi-cylinder piston pumps. The high-pressure pumps 22, 23 and their associated valves 31, 34 are arranged in parallel in the supply line 19. The pressure outputs of the high-pressure pumps 22, 23 are combined in a common supply line 19, so that the pressure accumulators 20, 40 can be jointly supplied with fuel by both high-pressure pumps 22, 33 or by only one high-pressure pump 22, 33. To control the pressure in the pressure accumulator 20, a pressure control valve 23 by means of which the fuel in the pressure accumulator 20 can return back via a return line 24 to the fuel tank 17 is assigned to said pressure accumulator 20. A pressure sensor 25 is also provided to monitor the pressure in the pressure accumulator 20.

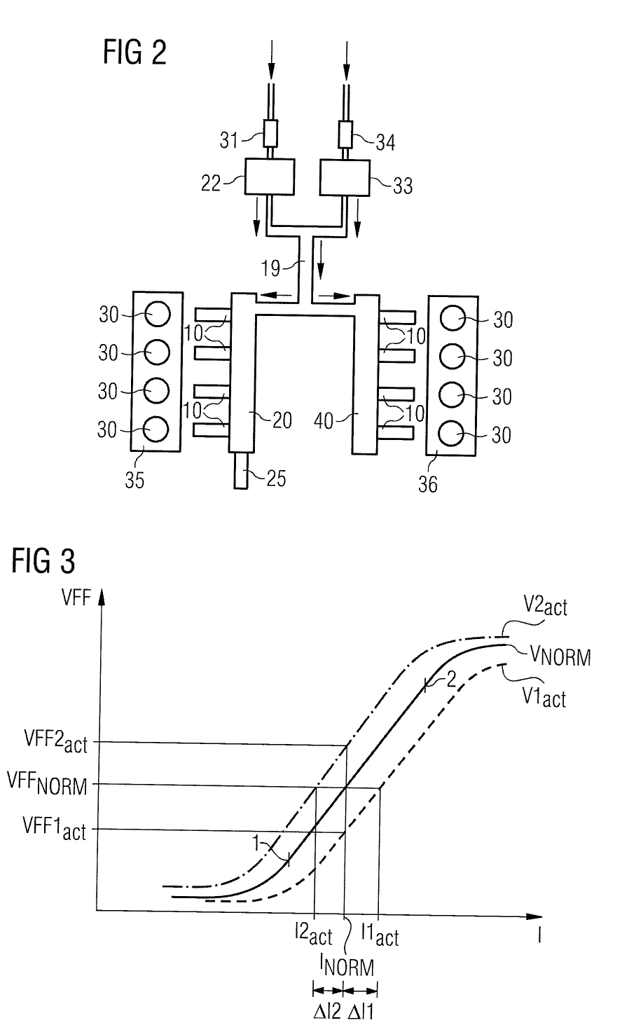

A control device 26, which is connected by signal and data lines to all actuators and sensors, is assigned to the internal combustion engine 1. Map-based engine control functions (KF1 to KF5) are implemented by software in the control device 26. The control signals are applied to the actuators of the internal combustion engine 1 and of the fuel supply system on the basis of the measured values of the sensors and of the map-based engine control functions. The control device 26 is thus connected via the data and signal lines to the fuel pump 18, the air temperature sensor 32, the air mass sensor 5, the throttle valve 6, the pressure control valve 23, the pressure sensor 25, the air mass sensor 5, the spark plug 10, the injection valve 19, the coolant temperature measuring sensor 14, the speed sensor 15 and the lambda sensor 16. The control device can, for example, be an PID controller. FIG. 2 shows a simplified representation of an alternative embodiment of the internal combustion engine 1 shown in FIG. 1. The internal combustion engine 1 shown in FIG. 2 differs from the construction shown in FIG. 1 only in that it has two cylinder banks 35, 26. Each cylinder bank, 35, 36 has four cylinders or four combustion chambers 30 and a pressure accumulator 20, 40 assigned to each cylinder bank 35, 36. An injection valve 10, which is supplied with fuel under pressure from the respective pressure accumulator 20, 40, is assigned to each combustion chamber 30. As the exemplary embodiment in FIG. 1 shows, the internal combustion engine 1 according to FIG. 2 has two high-pressure pumps 22, 23 each with assigned valves 31, 34 for the supply of the pressure accumulators 20, 40 with fuel. The direction of the fuel flow is shown by arrows in FIG. 2. The inlet side of both high-pressure pumps 20, 40 is connected to the fuel tank (not shown in FIG. 2). The pressure side of each of the high-pressure pumps 22, 33 is connected by a common supply line 19 to both pressure accumulators 20, 40. This guarantees that the high-pressure pumps 22, 33 can both separately and also jointly supply fuel under pressure to the pressure accumulator 20, 40 of each cylinder bank 35, 36. In FIG. 2, a pressure sensor 25 is also fitted to one of the pressure accumulators. It is, however, also possible as an alternative to provide both pressure accumulators 35, 36 with a pressure sensor.

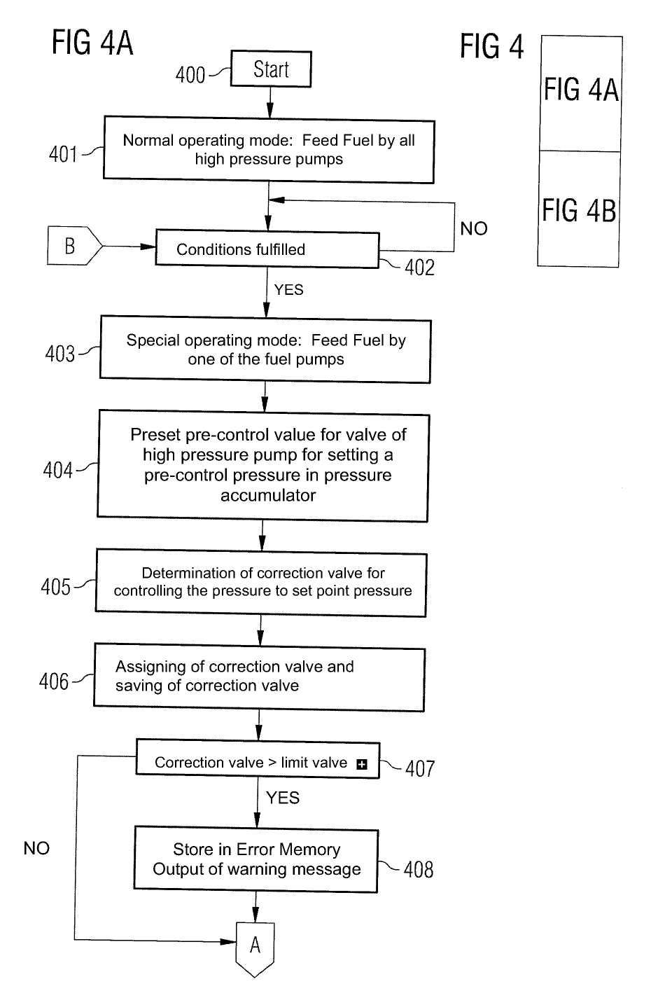

As already mentioned above, the valves 31, 34 are controllable valves 31, 34 whose degree of opening, and thus the amount of fuel flowing through, can be set relative to an excitation current from the control device. In the following it is assumed that both valves 31, 34 are identical. The operating characteristic, i.e. the dependency of the amount of fuel VFF flowing through the valves 31, 34 on the excitation current I, is shown in FIG. 3 in the form of a diagram. A standard characteristic curve V_{NORM} (shown in FIG. 3 as a solid line) serves as a basis for the adjustment of the amount of fuel VFF flowing through the valves 31, 34, for the purpose of controlling the pressure in the pressure accumulators. This standard characteristic curve V_{NORM} is usually created by the manufacturer on the basis of measurements on a limited number of test specimens, or by simulation. The actual characteristic of the individual valves 31, 34 can deviate from the standard characteristic curve V_{NORM} due to ageing or manufacturing tolerances. FIG. 2 shows examples of deviating characteristic curves for the first valve 31 and for the second valve 34. The actual characteristic of the first valve 31 is shown as a broken line V1_{act} and the actual characteristic of the second valve 34 is shown as a dotted line V2_{act}.

According to the standard characteristic curve V_{NORM}, an excitation current I_{NORM} must be applied to the valve to adjust the amount of fuel VFF_{NORM} flowing through the valves 31, 34. However, due to the deviating characteristics of both valves 31, 34 a smaller flow VFF1_{act} results for valve 31 when the excitation current I_{NORM} is applied and a greater flow VFF2_{act} for valve 34.

The deviating operating characteristics of the valves 31, 34 have a negative effect on the control of the pressure in the pressure accumulators. The control system functions in such a way that the control device calculates a specific amount of fuel depending on the operating point of the internal combustion engine 1, with the amount of fuel being supplied via the injection valves to the combustion chambers to generate the required torque. To be able to supply this amount of fuel, a predetermined desired pressure value must be set and maintained in the pressure accumulators 20, 24. This guarantees that the amount of fuel delivered from the pressure accumulators 20, 24 for injection is the same as the amount of fuel delivered to the pressure accumulators 20, 40 by the high-pressure pumps 22, 33. To control the pressure in the pressure accumulators 20, 40, the valves 31, 34 must therefore be controlled in such a way that the amount of fuel flowing through the valves 31, 34 corresponds to the amount of fuel metered to the combustion chambers. To do this, the control device 26 calculates a pilot control value for the excitation current I_{NORM} for the valves by means of the standard characteristic curve V_{NORM}, taking account of the amount of fuel to be metered VFF_{NORM}. The valves 31, 34 are then controlled using this excitation current I_{NORM}. A check is then carried out by means of the pressure sensor 25 to determine whether the pressure in the pressure accumulators 20, 40 has reached the desired pressure value. If a pressure deviation is detected, the control device 26 determines, for each valve 31, 34, a correction variable for the excitation current for valves 31, 34 in order to correct the pressure deviation and set the pressure in the pressure accumulators 20, 40 to the desired pressure value. In an ideal case, i.e. if the actual operating characteristics of all valves 31, 34 correspond to the standard characteristic curve V_{NORM}, the pilot control is very exact and only a slight deviation from the desired pressure value results after the pilot control. However, due to the deviations in the actual operating characteristics of the valves 31, 34, either too much or too little fuel flows through the valves 31, 34 and therefore into the pressure accumulators 20, 40, so that the preset desired pressure value in the pressure accumulators 20, 40 is not precisely achieved by the pilot control alone. Depending on the magnitude of the pressure deviation, the correction values for the excitation current, calculated by the control device, are correspondingly large, which can lead to unwanted stress of the integral component (I-component) of the control device and to an impairment of the dynamics and of the stability of the control system. Furthermore, the setting of the required desired pressure value in the pressure accumulator can be delayed due to the control dynamics, which can have a negative effect on the injection.

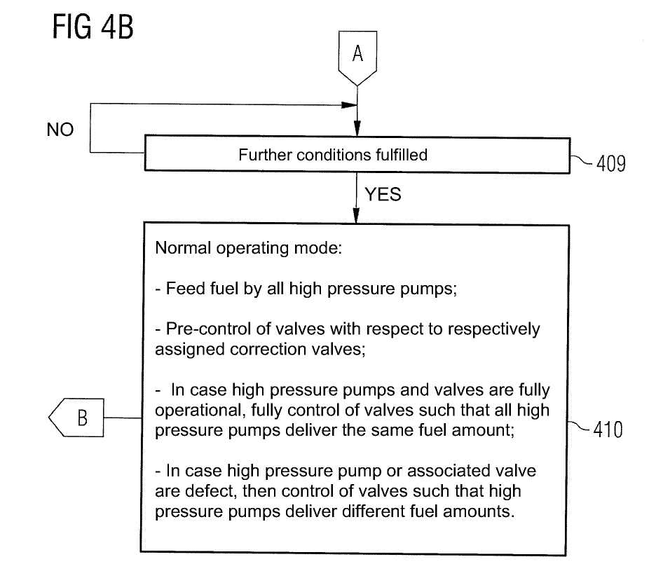

Using the flow diagram in FIG. 4, a first exemplary embodiment of a control process for the internal combustion engine 1 is explained, by means of which the aforementioned disadvantages can be rectified.

The method is started in step 400, for example by starting the internal combustion engine 1. In step 401, the high-pressure pumps are then operated in normal operating mode. In this normal operating mode, the control device 26 controls the valves 31, 34 associated with the high-pressure pumps 22, 33 in such a way that the pressure accumulators 20, 40 are supplied with fuel from both high-pressure pumps 22, 33. To do this, the valves 31, 34 are supplied with an excitation current, as previously described, and therefore opened to a specific degree, so that the pressure in the pressure accumulators 20, 40 reaches the preset desired pressure value. In step 402, a check is carried out by the control device 26 to determine whether one or more conditions are fulfilled, in order to change over from the normal operating mode to a special operating mode. In the special operating mode, the valves 31, 34 of the high-pressure pumps 22, 33 are controlled so that the pressure accumulators 20, 40 are supplied with fuel by only one of the high-pressure pumps 22, 33. This condition can then, for example, be fulfilled if the internal combustion engine 1 is in an operating range in which the delivery rate from only one of the high-pressure pumps 22, 23 is sufficient to maintain the pressure in the pressure accumulator 20, 40 to a preset desired pressure value. This is necessary in order to guarantee a stable fuel injection and combustion. In addition or alternatively, the condition can, for example, be fulfilled if the internal combustion engine 1 is in an essentially steady-state operating condition. This can, for example be detected by the control device 26 in that at least one operating variable of the internal combustion engine 1, preferably the speed or the fresh air mass flow in the intake tract, changes over a predetermined time period by not more than a predetermined limit amount. In addition or alternatively, the condition can then be fulfilled if the valve 31,34 of that particular high-pressure pump 22,33, which is meant to supply fuel to the pressure accumulators 20, 40 during the special operating mode, can, in the special operating mode, be operated in an operating range in which the valve has an essentially linear operating characteristic. As can be seen in FIG. 3, a linear operating behavior means an essentially linear correlation between the excitation current I and the amount of fuel VFF flowing through the valve (limited in FIG. 3 by digit 1 and 2). The operating behavior of the valve can be most accurately determined in this range, which has an advantageous effect on the accuracy of the pilot control and/or regulation of the pressure in the pressure accumulator 20, 40.

If the at least one condition is not fulfilled, the high-pressure pumps continue to be operated in the normal operating mode and the check in step 402 is repeated.

If however the at least one condition is fulfilled, the operation of the high-pressure pumps is then changed, in step 403, from the normal operating mode to the special operating mode.

As already mentioned, the valves 31, 34 of the high-pressure pumps are controlled in the special operating mode in such a way that the pressure accumulators 20, 40 are supplied with fuel from only one of the high-pressure pumps 22, 33. For this purpose, only the valve of one high-pressure pump remains open while the other valves 31, 34 are closed. To set the pressure in the pressure accumulators 20, 40 to the desired pressure value, a pilot control value I_{NORM} is specified by the control device, on the basis of the stored standard characteristic curve V_{NORM} and taking account of the amount of fuel VFF_{NORM} being injected into the combustion chamber, for the valve 31, 34 of the high-pressure pump which supplies fuel to the pressure accumulators 20, 40 for the excitation current for this valve 31, 34.

As however already explained further, the operating characteristic of the valve 31, 34 can deviate from the standard characteristic curve V_{NORM}. If, for example, the valve has an operating characteristic corresponding to characteristic curve V1_{Act}, this would mean that with a pilot control value I_{NORM} being specified for the excitation current, instead of the expected amount of fuel VFF_{NORM} only a smaller amount of fuel VFF1_{act} would flow through the valve 31, 34. In this case, a reduction in pressure in the pressure accumulator 20, 40 below the desired pressure value would be detected by the pressure sensor 25 because the amount of fuel VFF_{NORM} metered by the injection valves 10 is greater than the amount of fuel VFF1_{act} flowing through the valve. In this case, the control device 26, in step 405, determines a correction value ΔII for the excitation current of the valve 31, 34 which is, additionally, applied to the valve 31, 34 in order to correct the pressure in the pressure accumulators 20, 40 to the desired pressure value. For example, an output value of the control device 26, especially the value of the I component, in the corrected state, in the state in which the pressure in the pressure accumulator has reached the desired pressure value, can be used as the correction value ΔII, ΔI2. By means of this correction value ΔII, ΔI2, a corrected pilot control value for the excitation current of the valve finally results at which the required amount of fuel V_{NORM} can flow through the valve 31, 34. In this way, the amount of fuel flowing through the valve 31, 34 corresponds to the amount of fuel VFF_{NORM} injected through the injection valves and the pressure deviation is corrected.

If, however, the actual operating characteristic of the valve 31,34 corresponds to the characteristic curve V2_{Act}, if the pilot control value I_{NORM} were specified a greater amount of fuel VFF2_{Act} would flow through the valve 31,34 than the required amount of fuel VFF_{NORM}. In this case, the pressure in the pressure accumulators 20, 40 would increase because the amount of fuel VFF2_{Act} supplied to the pressure accumulators 20, 40 through the valve 31, 34 would be greater than the amount of fuel VFF_{NORM} metered through the injection valves 10. In the same way as with the previous case, the control device 26 in this case would also determine a correction value ΔI2 for the excitation current of the valve 31,34 as a reaction to the pressure deviation, so that the corrected excitation current I2_{ACT} would be present at the valve. With this corrected excitation current, the desired amount of fuel VFF_{NORM} would then flow through the valve 31, 34 and the pressure deviation would be corrected.

In step 406, the calculated correction value ΔII, ΔI2 is assigned to the corresponding valve 31, 34 and stored.

In step 407, the control device checks whether the correction value is greater than a predetermined limit value. The limit value in this case is chosen so that in the event of an overshoot it can be assumed that the high-pressure pump 22, 33 and/or associated valve 31, 34 are defective. The basic idea can be seen in that if the correction value is too high the operating characteristic of the high-pressure pump 22, 33 and/or of the associated valve 31, 34 deviates by a significant amount from the normal operating behavior to be expected with full functionality taking account of manufacturing tolerances. If this is the case, then in step 408 an entry in the fault memory of the control device 26 is made and/or a visual or acoustic warning signal is output. Otherwise, step 408 is skipped.

In step 409, the control device 26 checks whether at least one further condition is fulfilled and whether a changeover from the special operating mode to the normal operating mode can take place, This further condition can, for example, be fulfilled if the internal combustion engine 1 is operated in an operating range in which the delivery rate of the high-pressure pump 22, 23 is no longer sufficient even with valve 31,34 fully open to set the pressure in the pressure accumulator 20, 40 to the desired pressure value. Additionally or alternatively, the further condition can be fulfilled if the valve 31, 34 of the high-pressure pump 22, 23 is operated in an operating range in which there is no longer a linear relationship between the excitation current I and the amount of fuel VFF flowing through. In addition or alternatively, the further condition can be fulfilled if the determination of the correction value for the valve 31, 34 has already been completed.

If at least one of the further conditions is fulfilled, then, in step 410, a changeover from the special operating mode to the normal operating mode takes place. Otherwise, the high-pressure pumps 22, 23 continue to be operated in the special operating mode and the check according to step 409 is repeated.

After the changeover to the normal operating mode, the pressure accumulators 20, 40 are again supplied with fuel by all the high-pressure pumps 22, 33. To do this, the valves 31, 34 of all the high-pressure pumps 22, 33 are opened by a suitable amount. The pressure in the pressure accumulators 20, 40 is initially set to the desired pressure value in this case also firstly by the specification of a corrected pilot value I_{NORM, corr} for the excitation current, which is based on the pilot control value I_{NORM} determined according to the standard characteristic curve V_{NORM} and additionally on the correction value ΔII, ΔI2 determined in step 405. In a simple embodiment, the corrected pilot value I_{NORM, corr} is obtained by adding the standard pilot control value I_{NORM} to the correction value ΔII, ΔI2.

If no defect in the high-pressure pumps 22, 33 and/or the associated valves 31, 34 was found in step 407, the valves 31, 34 are operated in normal operating mode in such a way that all the high-pressure pumps 22, 33 deliver the same amount of fuel. To do this, the control device divides the amount of fuel VFF_{NORM} to be supplied to provide the required torque or power output by the number of high-pressure pumps 22, 33 and controls the respective associated valves 31, 34 so that each valve supplies this uniform fraction of the total amount of fuel VFF_{NORM} to the pressure accumulators 20, 40. This guarantees that each fuel pump 22, 33 produces the same delivery rate over the service life of the internal combustion engine 1, thus achieving an equal distribution of the delivery load and enabling the operating safety of the internal combustion engine 1 to be increased.

If, however, in step 407, a defect in one of the high-pressure pumps 22, 33 and/or the valves 31, 34 was found, the valves of the high-pressure pumps 22, 33 are controlled in such a way that the high-pressure pumps 22, 33 supply different amounts of fuel to the pressure accumulators 20, 40. This is achieved in that the reduced delivery rate of the defective fuel pump 22, 33 is compensated for by the remaining, fully functional, fuel pumps 22, 33, so that the pressure in the pressure accumulators 20, 40 is set to the desired pressure value. In doing so, the valves 31, 34 can be controlled in such a way that all the valves are operated in the linear operating range (limited in FIG. 3 by points 1 and 2), thus substantially simplifying control. By this means, the internal combustion engine can continue to be operated in a wide load range even if one fuel pump 22, 33 or one of the valves 31, 34 is defective.

Continuing from step 410, steps 402 to 410 can now be repeated, with steps 403 to 409 being carried out in turn for all valves 31, 34. Advantageously, steps 403 to 409 are performed individually for all valves 31, 34. This means that an individually assigned correction value is determined and stored for each of the valves 31, 34. By means of this adaption process, deviations of the operating characteristics of all the valves 31, 34 from the specified standard operating characteristic are balanced. After an individual correction value has been determined for all the valves 31, 34, it can be ensured that all the high-pressure pumps 22, 33 produce the same delivery rate, thus enabling irregularities in the service life of the high-pressure pumps 22, 33 to be avoided. At the same time, the control of the pressure in the pressure accumulator 20, 40 to the desired pressure value is faster and more exact. The reason for this is that the pilot control values for the individual valves 31, 34, determined on the basis of the standard characteristic curve V_{NORM} and the correction values are very exact and a re-correction using the I component of the control device 26 is largely minimized. This also increases the stability of the complete control process.

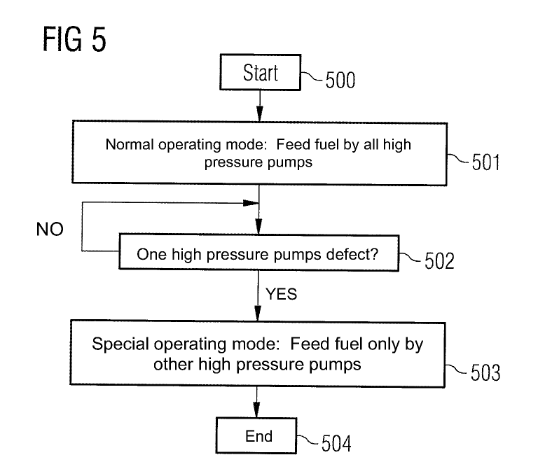

FIG. 5 shows a further exemplary embodiment of a control method. This method is to be used on internal combustion engines with two high-pressure pumps 22, 33.

The process is started in step 500, for example by starting the internal combustion engine 1. High-pressure pumps are first operated in the standard operating mode, in step 501. As in the exemplary embodiment in FIG. 4, the pressure accumulators 20, 40 are supplied with fuel by all the high-pressure pumps 22, 33.

In step 502, the control device 26 checks whether one of the high-pressure pumps 22, 33 is defective. If this is not the case, the high-pressure pumps 22, 33 continue to be operated in the normal operating mode.

In the event of a defect in one of the high-pressure pumps 22, 33, a changeover to the special operating mode takes place in step 503. The pressure accumulators 20, 40 are then supplied with fuel by the respective other, correctly functioning, high-pressure pump 22, 33. To do this, the valve 31, 34 of the defective high-pressure pump 22, 33 is closed and the valve 31, 34 of the functioning high-pressure pump 22, 33 is controlled so that the amount of fuel to be supplied to set the desired pressure value in the pressure accumulators flows through this valve 31, 34. Because the amount of fuel delivered by the functioning high-pressure pump 22, 23 is limited, it may be that the internal combustion engine 1 can operate only up to a certain low load limit.

The process is ended in step 504 when the internal combustion engine shuts down.

This embodiment of the method offers advantages for the emergency operation of the internal combustion engine 1 in the event of a defective high-pressure pump 22, 33. All the pressure accumulators 20, 40 continue to be supplied with fuel by the functioning high-pressure pump 22, 23, so that all the cylinder banks can also continue to operate in this situation. This increases the comfort. Furthermore, the functioning high-pressure pump 22, 33 can be operated up to its power limit, so that an adequate torque can be generated by the internal combustion engine 1 even during emergency operation.

1. A method for controlling an internal combustion engine with
at least one pressure accumulator in which fuel is stored under pressure, in order to supply fuel under pressure to at least one injection valve,
at least two high-pressure pumps which are connected to the at least one pressure accumulator in such a way that said high-pressure pumps can supply the at least one pressure accumulator with fuel either jointly or separately,
the method comprising the step of:
if at least one condition is fulfilled, operating the high-pressure pumps in a special operating mode in which only one of the high-pressure pumps supplies fuel to the at least one pressure accumulator and otherwise the high-pressure pumps are operated in a normal operating mode in which the at least two high-pressure pumps jointly supply the at least one pressure accumulator with fuel.

2. The method according to claim 1, wherein
a controllable valve being assigned to each of the at least two high-pressure pumps, by means of which the amount of fuel supplied from the respective high-pressure pump to the at least one pressure accumulator can be adjusted,
a control device being assigned to the internal combustion engine, which is connected to the valves and controls the pressure in the pressure accumulator by specifying a separate pilot control value for each valve,
the method further comprising the steps of:
to set the pressure in the pressure accumulator in the special operating mode, applying a pilot control value to the valve of the particular high-pressure pump which supplies fuel to the at least one pressure accumulator and then, determining a correction value for this valve, in order to correct the pressure in the pressure accumulator to a preset desired pressure value, and
assessing the functional capability of the respective high-pressure pump on the basis of the determined correction value.

3. The method according to claim 2, wherein the respective high-pressure pump being assessed as defective if the associated correction value exceeds a preset limit value.

4. The method according to claim 2, wherein if one of the high-pressure pumps is assessed as defective, the valves being controlled in the succeeding normal operating mode in such a way that the high-pressure pumps deliver different amounts of fuel to the at least one pressure accumulator.

5. The method according to claim 4, wherein the valves being controlled in such a way that they are in an operating range in which there is an essentially linear relationship between the correcting variable for the respective valve and the amount of fuel flowing through the respective valve.

6. The method according to claim 1, wherein
a controllable valve, by means of which the amount of fuel delivered by the respective high-pressure pump to the at least one pressure accumulator can be set, being assigned to each of the at least two high-pressure pumps,
a control device being assigned to the internal combustion engine, with the control device being connected to the valves and the pressure in the pressure accumulator being controlled by the specification of a pilot control value for each of the valves,
the method further comprising the steps of:
in special operating mode, to set the pressure in the pressure accumulator, initially supplying a pilot control value to the valve of the particular high-pressure pump which supplies fuel to the at least one pressure accumulator and then, determining a correction value for this valve in order to correct the pressure accumulator to a preset desired pressure value, and
during the succeeding control of the pressure in the pressure accumulator in the normal operating mode, carrying out the pilot control of this valve taking account of this correction value.

7. The method according to claim 2, wherein the process steps being performed with respect to all the valves and the determined correction values, being assigned to the respective valves.

8. The method according to claim 6, wherein a control device controlling the valves during the control of the pressure in the normal operating mode in such a way that each high-pressure pump delivers the same amount of fuel to the at least one pressure accumulator.

9. The method according to claim 2, wherein the at least one condition then being fulfilled if the valve of the particular high-pressure pump that is meant to supply fuel to the pressure accumulator during the special operating mode can be operated in the special operating mode in an operating range in which there is an essentially linear relationship between the correcting variable for the valve and the amount of fuel flowing through the valve.

10. The method according to claim 1, wherein the at least one condition then being fulfilled if the internal combustion engine is in an operating range in which the delivery rate of one of the high-pressure pumps is sufficient to set the pressure in the pressure accumulator to the desired pressure value.

11. The method according to claim 1, wherein the internal combustion engine having two pressure accumulators and the at least one condition then being fulfilled if one of the high-pressure pumps is found to be defective.

12. The method according to claim 1, wherein the at least one condition then being fulfilled if at least one operating variable of the internal combustion engine changes by not more than a preset limit amount over a specified time period.

13. The method according to claim 1, wherein a changeover from the special operating mode to the normal operating mode taking place during the fulfillment of a further condition.

14. The method according to claim 13, wherein the further condition then being fulfilled if the internal combustion engine reaches an operating range in which the delivery rate of the high-pressure pump is no longer sufficient to set the pressure in the pressure accumulator to the desired pressure value.

15. The method according to claim 13, wherein the further condition then being fulfilled if the valve of the high-pressure pump is operated in an operating range in which there is no linear relationship between the control variable for the valve and the amount of fuel flowing through the valve.

16. The method according to claim 13, wherein the further condition then being fulfilled if the determination of the correction value for the valve has been completed.

17. A internal combustion engine comprising
at least one pressure accumulator in which fuel is stored under pressure, in order to supply at least one injection valve with pressurized fuel
at least two high-pressure pumps which are connected to at least one of the pressure accumulators in such a way that they can supply fuel to this at least one pressure accumulator either jointly or separately, and
a control device which is operable
to adjust the amount of fuel which can be delivered by the high-pressure pumps to the pressure accumulators, and
if at least one condition is fulfilled, to operate the high-pressure pumps in a special operating mode in which only one of the high-pressure pumps supplies fuel to the at least one pressure accumulator, and otherwise, to operate the high-pressure pumps in a normal operating mode in which the at least two high-pressure pumps jointly supply fuel to the at least one pressure accumulator.

18. The internal combustion engine according to claim 17, wherein the high-pressure pumps being single-cylinder piston pumps.
